(19) United States
(12) Patent Application Publication
(10) Pub. No.: US 2010/0075666 A1
(43) Pub. Date: Mar. 25, 2010

(54) COMMUNICATION SYSTEM

(76) Inventor: Neil Robert Garner, Norfolk (GB)

Correspondence Address: AMSTER, ROTHSTEIN & EBENSTEIN LLP, 90 PARK AVENUE, NEW YORK, NY, 10016, US

(21) Appl. No.: 12/448,991

(22) PCT Filed: Jan. 18, 2008
(86) PCT No.: PCT/GB2008/000174

§ 371 Date: Nov. 2, 2009

(30) Foreign Application Priority Data
Jan. 18, 2007 (GB) 0700968.1

(51) Int. Cl. H04W 4/00; H04B 5/00; G06F 15/16

(52) U.S. Cl. 455/426.1; 455/41.1; 709/203

(57) ABSTRACT

A communication system, comprises processing means located on a near field communications (NFC) handset incorporating a storage medium for storing signals received, in use, from a tag which is part of a display such as a poster; said storage medium being adapted to store a plurality of signals received, in use, from a plurality of disparate tags; wherein said signals contain at least a Uniform Resource Locator (URL), and one or more display specific elements such as a spatial indicator; and wherein said processing means is adapted to upload signals to a remote server when said handset is on-line mode of use allowing remote processing means to record and profile a user's interaction with said displays; and is adapted for downloading signals for personalising the user's interaction with said handset when said handset is an off-line mode of use.

### FIELD OF THE INVENTION

The invention relates to communication systems and in particular systems, which operate at least in part with Near Field Communications (NFC).

More particularly, the invention relates to contextual Near Field Communications.

In more specific embodiment, the invention relates to off-line data collection of information from smart media, data collection, profiling of user behaviour, and facilitating peer-to-peer sharing of data.

### BACKGROUND TO THE INVENTION

Near Field Communications (NFC) is a technology, which has been introduced to mobile phone handsets. It allows information to be transferred to the handset and to launch an application in response to waving the handset over or tapping a radio frequency (RF) ID tag.

One example of prior art handset is the Nokia 3220 handset which incorporates a limited amount of memory per application of 125K. The phones come with an NFC shell, which replaces the usual plastic shell. The NFC interface is a wireless communication interface acting over distances of about 2-5 centimetres. Such handsets can be used to exchange data between two NFC enabled handsets incorporating an RFID chip or to read data from a passive RFID tag. An NFC chip is said to be active since it draws power from the phone battery whilst a passive NFC tag may be adapted to draw its power from the electromagnetic field of a neighbouring active device during a transaction.

The following prior art documents are acknowledged: US2002/0116268, WO2006/049785, GB2413194, and WO2005/006222

### SUMMARY OF THE INVENTION

In a first broad independent aspect, the invention provides a communication system, comprising processing means located on a near field communications (NFC) handset incorporating a storage medium for storing signals received, in use, from a tag which is part of a display such as a poster; said storage medium being adapted to store a plurality of signals received, in use, from a plurality of disparate tags; wherein said signals contain at least a Uniform Resource Locator (URL), and one or more display specific elements such as a spatial indicator; and wherein said processing means is adapted to upload signals to a remote server when said handset is in an on-line mode of use allowing remote processing means to record and profile a user's interaction with said displays; and is adapted for downloading signals for personalising the user's interaction with said handset when said handset is in an off-line mode of use.

It may also allow the whole set of information to be used off-line before deciding to go on-line to see more.

In a second broad independent aspect, the invention provides a communication system, comprising processing means located on a Near Field Communications (NFC) handset which is adapted to restore and transmit signals received from a tag which is part of a display such as a poster; wherein said signals contain at least a Uniform Resource Locator (URL), and one or more display specific elements such as a spatial indicator; and processing means located on a remote server with which the handset communicates signals in order to access web-based services relating specifically to said display. This is particularly advantageous because it provides a physical access point and/or a pointer to the mobile Internet. It also allows information, which is not currently available via the Internet such as location and type of display to be obtained by the remote server to provide contextual Internet services. It also allows an application to store signals relating to a physical interaction on a remote server.

In a subsidiary aspect in accordance with the invention's broadest independent aspect, said remote server stores signals representative of a user's usage profile.

In a further subsidiary aspect, said processing means is adapted to send signals to said handset dependent upon a user's usage profile.

In a further subsidiary aspect, said processing means and said handset are synchronised; whereby said processing means is adapted to send signals to said handset when said handset is online without the user having necessarily gone online to run said system.

In a further subsidiary aspect, said remote server stores signals representing user data; the user data being collected by the server addressing single sporadic questions. This allows gradual data collection to occur (so-called creep) instead of having the user fill in questionnaires.

In a further subsidiary aspect, the communication system comprises a tag incorporating a memory chip and an aerial wound around the perimeter of the chip. This is particularly advantageous because it allows the tag to be particularly compact in order to be readily incorporated into fliers, mailers, personal devices (e.g. key fobs), posters, books, signage or the like.

In a further subsidiary aspect, the tag is covered with adhesive. This is also particularly advantageous because it allows the tag to be secured onto posters, books, signage or the like.

In a further subsidiary aspect, the communication system comprises a tag, which is connected to a power source and communicates signals to a remote database. This allows signals, which are present on the tag to be dynamically changed from the remote database. This allows the tag to be optionally attached to a screen and to change the signals (or links) on the tag as the screen would be made to change (for example to display a rolling advertisement). It may include a data package, which changes as the advertisements change. It may also allow the whole set of information to be used off-line before deciding to go on-line to see more.

In a further subsidiary aspect, said tag is synchronised with video or audio on any appropriate device.

In a subsidiary aspect, said tag is incorporated as part of an electronic display. This may be for example a TV screen, which is showing a stream of programmes or advertisements.

In a further subsidiary aspect, the communication system comprises a tag in the form of a fob such as a key fob. This allows the system to operate without the presence of a poster or other display. The key fob would represent an alternative to having to navigate the phone menu structure to find an application since the fob could contain the necessary tag signals to directly launch an application.

In a further subsidiary aspect, said signals comprise a uniform resource identifier, a brand ID and a message authentication code.

In a further subsidiary aspect, said signals comprise a tag location.

In a further subsidiary aspect, said signals comprise a tag ID and a description suitable for being displayed on a handset.

In a further subsidiary aspect, said signals contain a uniform resource identifier (URI), a tag location, a tag ID, a description suitable for being displayed on a handset, a brand ID and an encrypted message authentication code (MAC).

This provides a unique format, which can be checked and verified by the application.

The MAC may be critical for off-line usage as this is what is checked before the user goes on-line.

In a further subsidiary aspect, the system further comprises storage for storing signals representative of a user's interaction with a tag; said storage being in the form of a history and/or a favourites list; and a transmitter operating in conjunction with said storage allow transmission of signals from said storage to another user, whereby peer to peer communication is established.

In a further subsidiary aspect, said transmitter operates by Short messaging service (SMS) or near field communication (NFC); or any Internet service.

In a further subsidiary aspect, said signals comprise a message authentication code, a tag ID, a brand ID, a title, and a description; and said system incorporate a storage for storing said signals; and a processing means for reviewing said signals without requiring on-line access.

The tag ID may be a unique ID for a given tag. A brand ID may be employed for displaying the right advertiser branding. The URL as introduced in the broadest aspects of the invention, indicates to the user where to go next if the user decides to go on-line. The title may be incorporated for display. The description may be incorporated for understanding what the on-line content is. The spatial location as introduced in the broadest aspects may be for knowing where the poster is. Optionally a version may be included for managing the upgrade path of more complex tags in the future. The MAC may be critical for off-line usage as this is what is checked before the user goes on-line. Optionally, the user interface script may be employed for rendering a more complex display without needing to go on-line.

In a further subsidiary aspect, said system further incorporates means for on-line access of detailed information related to said tag and/or signals.

In a further subsidiary aspect, said system further incorporates means for uploading collected signals and/or means for downloading further signals representative of promotional information and/or targeted advertising when said user accesses said remote server.

In a further subsidiary aspect, said signals comprise user interface scripts to facilitate a mobile communication device to display a user interface without the mobile communication device having to access online signals.

In a further subsidiary aspect, said scripts contain one or more of the following: menu items, form data entry elements and multiple links to on-line resources.

In a further subsidiary aspect, said signals contain at least a Uniform Resource Locator (URL) which points to a user interface script for displaying one at least of the following: menus, forms, images, buttons, a link to a mobile internet site, a download link for digital content e.g. images, music, videos, and/or applications.

A method of doing business comprising the steps of:
Providing a number of Near Field Communication (NFC) tags;
Recording individual interactions of a handset with said tags; and
Charging for a service dependent upon said recorded interactions.

In a further broad independent aspect, the invention provides a method of communication, comprising the steps of:
providing processing means located on a near field communications (NFC) handset incorporating a storage medium for storing signals received, in use, from a tag which is part of a display such as a poster;
storing a plurality of signals received, in use, from a plurality of disparate tags; wherein said signals contain at least a Uniform Resource Locator (URL), and one or more display specific elements such as a spatial indicator; and
uploading signals to a remote server when said handset is in an on-line mode of use allowing remote processing means to record and profile a user's interaction with said displays; and downloading signals for personalising the user's interaction with said handset when said handset is in an off-line mode of use.

In a further broad independent aspect, the invention provides a method of communication comprising the steps of:
providing processing means located on a near field communications (NFC) handset which is adapted to store and transmit signals received from a tag which is part of a display such as a poster; wherein said signals contain at least a Uniform Resource Locator (URL), and one or more display specific elements such as a spatial indicator; and
establishing communication between a remote server and a handset dependent upon said signals in order to access web-based services relating specifically to said display.

In a subsidiary aspect, the method further comprises the step of storing signals representative of a user's usage profile.

In a subsidiary aspect, the method further comprises the step of sending signals to said handset dependent upon a user's usage profile.

In a subsidiary aspect, the method further comprises the step of synchronising said remote processing means and said handset processing means; whereby said remote processing means is adapted to send signals to said handset processing means when said handset is online without the user having necessarily gone online to run said system.

In a subsidiary aspect, the method further comprises the steps of storing on a remote server signals representing user data; and collecting user data by a server addressing single sporadic questions.

In a subsidiary aspect, the method further comprises the steps of connecting a tag to a power source and establishing communication of signals from said tag to a remote database.

In a subsidiary aspect, the method further comprises the steps of synchronising a tag with video or audio on any appropriate device.

In a subsidiary aspect, the method further comprises the step of incorporating a tag as part of an electronic display.

In a subsidiary aspect, the method further comprises the step of emitting signals with a message authentication code.

In a subsidiary aspect, the method further comprises the step of generating signals comprising a uniform resource identifier, a brand ID and a message authentication code.

In a subsidiary aspect, the method further comprises the step of generating signals comprising a tag location.

In a subsidiary aspect, the method further comprises the step of generating signals comprising a tag ID and a description suitable for being displayed on a handset.

In a subsidiary aspect, the method further comprises the steps of storing signals representative of a user's interaction with a tag, in the form of a history and/or a favourites list; and transmitting signals from said storage to another user; whereby peer to peer communication is established.

In a subsidiary aspect, the method further comprises the step of transmitting by Short messaging service (SMS) or near field communication (NFC).

In a subsidiary aspect, the method further comprises the steps of communicating signals comprising a message authentication code, a tag ID, a brand ID, a title, and a description; storing said signals; and reviewing said signals without requiring on-line access.

In a subsidiary aspect, the method further comprises the steps of facilitating the on-line access of detailed information related to said tag and/or signals.

In a subsidiary aspect, the method further comprises the steps of uploading collected signals and/or downloading further signals representative of promotional information and/or targeted advertising when said user accesses said remote server.

In a subsidiary aspect, the method further comprises the step of displaying a user interface without the mobile communication device having to access online signals.

In a subsidiary aspect, the method further comprises the step of providing scripts containing one or more of the following: menu items, form data entry elements and multiple links to on-line resources.

In a subsidiary aspect, the method further comprises the steps of communicating signals containing at least a Uniform Resource Locator (URL) which points to a user interface script for displaying one at least of the following: menus, forms, images, buttons, a link to a mobile interne site, a download link for digital content e.g. images, music, videos, and/or applications.

### BRIEF DESCRIPTION OF THE FIGURES

FIG. 1 shows an example of an overall architecture of the system.

FIG. 2 shows a diagram of the process flow.

FIG. 3 shows a diagram of a further process flow.

FIG. 4 shows a diagram of launching an application with a personalised tag.

FIG. 5 shows a diagram of targeted promotional data.

FIG. 6 shows a diagram of active tags.

FIG. 7 shows a diagram of personal Webtags.

FIG. 8 shows a diagram of peer-to-peer transfer of information.

FIG. 9 shows a diagram of a business method.

### DETAILED DESCRIPTION OF THE FIGURES

In an embodiment of the invention, the communication system is partially a handset application and a partially a back-end server application. The handset application uses processing means to automatically manage Near Field Communications (NFC) transactions. The handset is adapted to store a history and a list of favourites. Furthermore, the communication system allows the packaging of signals to transfer information to other operators such as friends and colleagues. The signals may be packaged in a so-called “smart tag”.

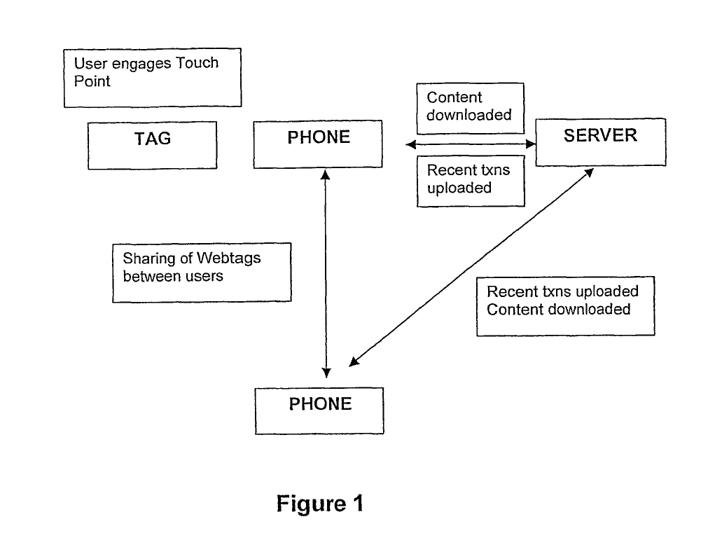

As shown in FIG. 1, a two-way communication takes place between an interface on the handset and an interface on a remote server. Recent transactions are uploaded to the remote server whilst content is downloaded from the remote server. The remote server application stores information about the user's behaviour relating to unique so-called smart-posters, which are a kind of display incorporating a relatively small radio frequency ID chip or tag.

So called “smart-posters” have an RFID chip acting as a tag to provide a physical access point to the mobile Internet. The signals transmitted by the tag comprise standard web-links with the addition of physical location and virtual location links. These may be used in the same way as Internet links in order to access information, purchase, download, register, vote, etc. The additional information, which is contained in the signals, may be location and type of advertisement. The handset may also be set to act as a contactless payment card provided the payment system is set up in the handset and remote server application. The system may also accept payment from other cards. It may also accommodate peer-to peer payments between two neighbouring handsets.

The radio frequency ID tag envisaged is preferably paper thin and coated with a layer of adhesive. The overall dimensions of the tag are preferably comprised between 1 cm squared and five cm squared. More preferably, the size of the tag is about two centimetres squared. Whilst these dimensions are mentioned specifically other dimensions greater than 5 centimetres squared are envisaged as well. It consists of a small memory chip with a copper wire aerial wound around the perimeter of the tag. Alternatively, it consists of memory and processor. On its own the tag may be called passive but when it is brought into proximity of an active NFC chip located on a handset, the field of the active device induces a small electric current in the aerial of the tag which provides just enough power for a dialogue between the handset and tag.

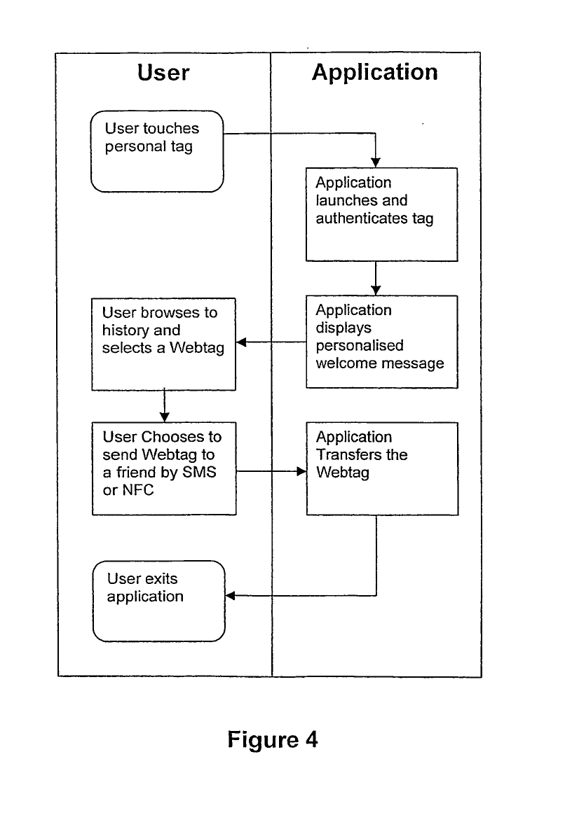

“smart posters” are envisaged and constitute an interactive advertising poster. These are displayed generally in public and encourage passers-by to interact with the poster by touching the poster with their phone or by positioning the phone in close proximity to poster's tag area. The area to be touched contains an RFID tag with a URI (Uniform Resource Identifier) stored on the memory chip. When the user touches the tag with his/her phone, the URI is read from the tag and the phone acts on the data accordingly. For example, the handset connects to the URI's location on the Internet. (For example, FIG. 4).

“smart media” is also envisaged and would extend to magazines, catalogues, fliers, mailers, key fobs, cards, and other artifacts which are able to contain RFID tags either attached or embedded within them but contain the same data package.

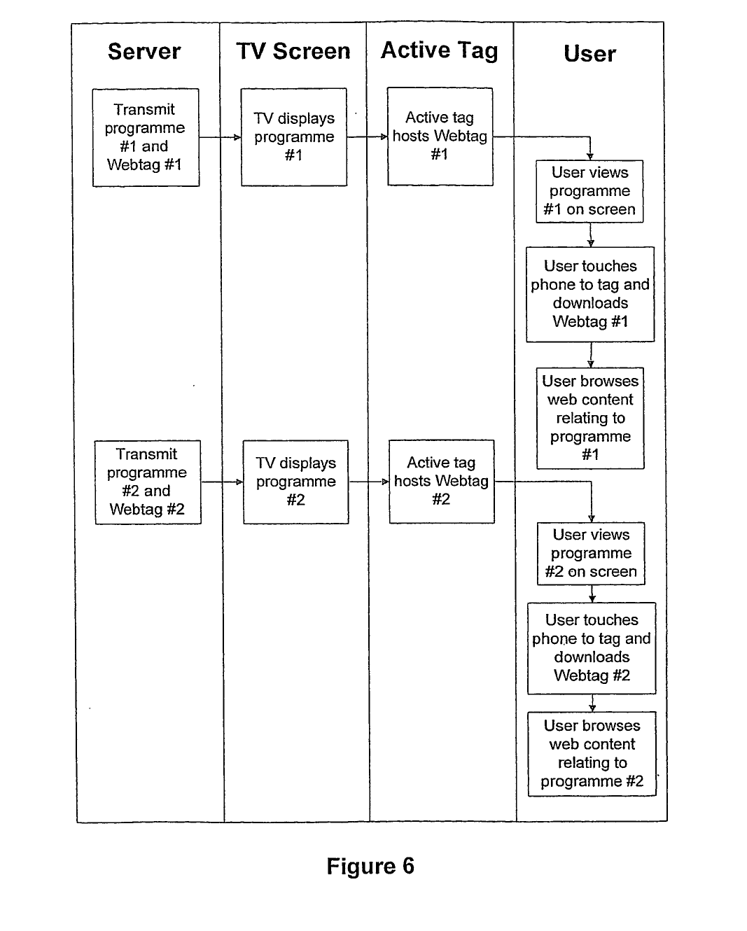

The invention also envisages optionally the use of an active tag as part of the “smart poster”, which would be connected dynamically from the back-end database or local computer algorithm. The signals, which are stored and may be up loaded to a handset at any given time, can be changed dynamically from the back-end database. This configuration is particularly advantageous because it allows a tag to be attached to a screen and to change the display on the screen such as for rolling advertisements. (For example, FIG. 6).

The signals stored on the tag may incorporate a core URL (Uniform Resource Locator such as a website address and the following additional information: a tag URI (Uniform Resource Identifier) specification version; a tag location; a tag ID; a description; a brand ID; and an encrypted message authentication code (MAC).

The location allows the performance of geographical analysis by the remote server. The specification version allows protection against future updates. The tag ID is a unique identifier for any given tag. The description contains user-friendly text, which may be selected by the application for display on the user's handset. The application will display the description information only since the components are primarily machine-readable and would therefore not be readily understood by a user. The brand ID may be used by the application to load appropriately formatted branding onto the application splash screen whilst it is connecting to the Internet.

The communication system would also provide software on the handset of a user.

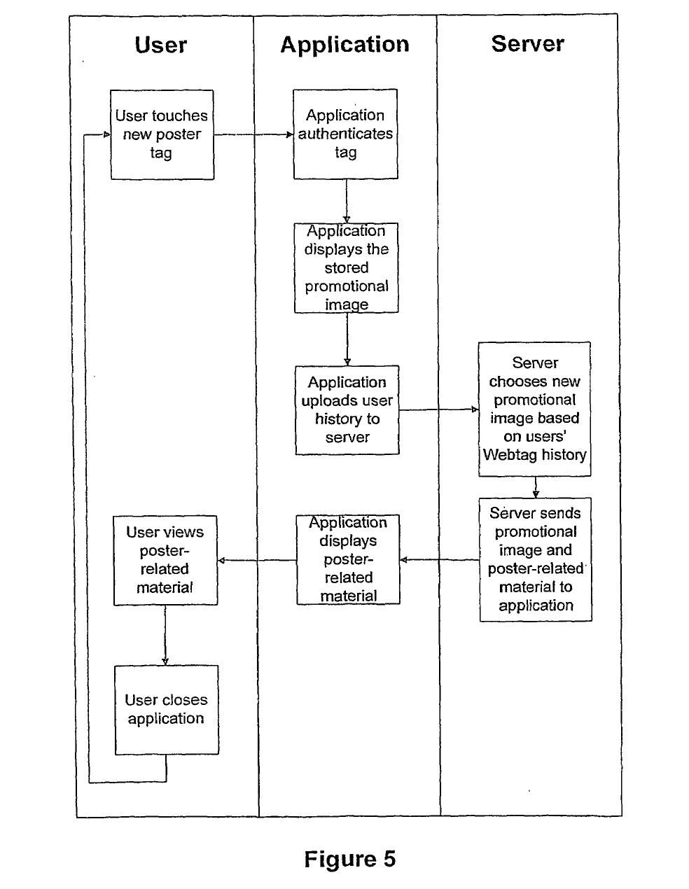

The handset software has at least the following purposes:
Enabling the user to manage their NFC transactions by storing the unique signals of their favourite sites, keeping a history log of recent transactions, sending signals to other users by NFC or SMS (Short Message Service) and authenticate signals received from tags as coming from a legitimate and trusted source (for example, FIG. 6).
Up loading the transaction logs to a web-server, as well as downloading personalised promotional material for the user based on the previous transaction marks (for example, FIG. 5).
Providing a streamlined alternative to a mobile internet site (which may include the handset WAP browsers) and text from the advertising brand can be downloaded and displayed within the application, instead of having to connect to the brands mobile internet site. This allows the application to be used by brand owner who does not have or does not want a mobile Internet site. This application provides a low maintenance presence on mobile systems. This system may also be adapted to link to an external mobile Internet site (for example a WAP site) from within the application. This would allow streamlined and focussed functionality with more menus and branding plus NFC-features which can be embedded into the site which is at the time of writing not possible with mobile internet browsers. The system allows linkage to any content through URLs; whereby mobile Internet sites, digital content, application download and other URL links are possible.
Providing a secure platform for M-Commerce payments. Credit card details are envisaged to be stored securely in a virtual wallet managed by the application. It is possible that payment and address details are stored server side and passed to the brand owner for payment at the permission of the user. Thus the application prevents both the storing of details locally and the transferring of them over the air.

The handset application communicates with the server each time the user goes online.

The user has downloaded or has pre-installed the software on his/her mobile, the user initiates the flow of signals by agreeing to interact with a smart-poster.

After tapping the phone to the poster, the signals of the tag are read by the phone and the application launches automatically. The client side application is adapted to perform a check that the signals are trusted by reading the message authentication code (MAC) provided as part of the signals uploaded to the handset. If the site is trusted, the user will be asked if they wish to connect to the network. Whilst the phone is connecting to the network, appropriate branding will be displayed on screen (for example, the brand owner of the smart-poster).

The application also envisages the scenario when a user interacts with a smart poster whilst off line. In this situation a menu will be generated by the application where a user will be presented with the following options: save item, add to favourites, view history, send to friend, go to wallet and/or exit.

Optionally, the MAC is validated on both the handset and the server, which would provide an additional level of security. This is critical to allow for more off-line usage. With this option, the user does not necessarily proceed on-line immediately. A lot more can be done off-line using the potential to store user interface scripts on tags. The rest of the description is correct when the user goes on-line.

When the connection has been successful, the transaction signals are uploaded to the web-server and any promotional material or software updates are downloaded as well as the poster related content.

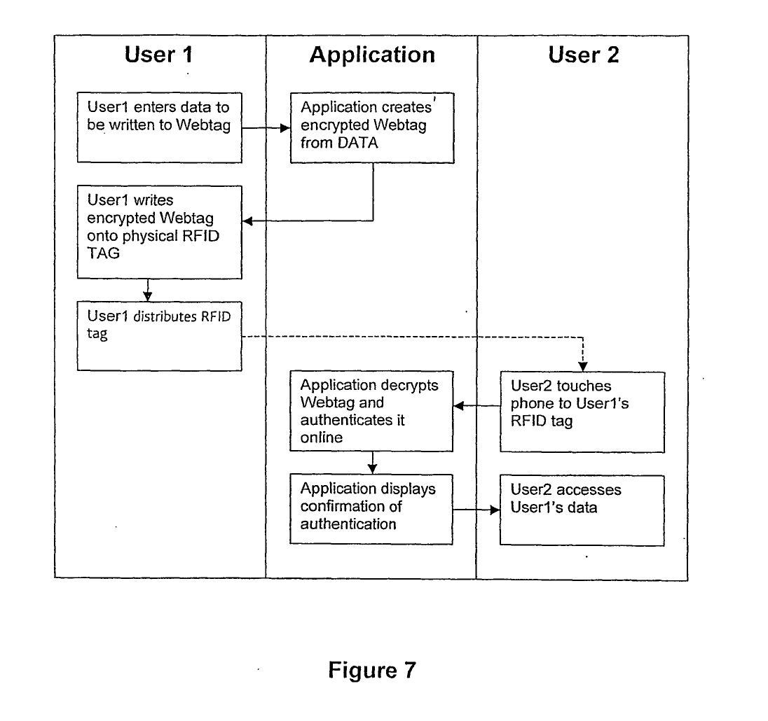

Following these steps, the user will have the option of storing the tag signals to his/her “favourites” list in the handset application or to pass it on to another user such as a friend by SMS (Short Message Service), Bluetooth or other connectivity technology or NFC (Near Field Communications), (for example, FIG. 7).

In the case where the signals are passed onto a friend by NFC, the users touch their phones together and the recipient's handset acts as if it has touched the “smart-poster”. When the signal is transferred by SMS, the friend will receive an SMS asking whether to launch the application and once this is agreed the results are again identical to touching a so-called “smart-poster”. The remote server will store the user's phone number as the application captures it.

When a signal is passed from one user through to the other through NFC, it has additional data appended to it: a unique ID of the application on the sender's phone, a time and date, and a new Message Authentication Code (MAC) calculated from the newly appended signal.

A typical message authentication code used for this application includes a piece of data from a known shared secret known by two parties. Algorithms are known by both parties to cryptographically derive the data.

When a user selects to send a signal by SMS the application is adapted to link to the phone address book in order to choose a recipient. After pressing “send”, the application will connect to the network and upload the following details to a remote server: a phone number of intended recipient, an application ID of the application on the sender's phone and an original signal.

Once this data is received by the server, the server is adapted to determine whether the recipient has the application stored already by checking the registration marks. If not, the new user will be sent an appropriate message instructing him/her how to obtain the application. If the recipient does not have the application stored then a message is sent out which can launch the application when opened. The signal sent by the SMS is condensed, by removing the appended sender application identifier and time stamp.

The handset application may include simple payment functionality. A payment wallet may be PIN protected and enable the user to store credit card details remotely and/or locally. If the brand owner wishes to sell them some content through the application then it can be paid for simply by the user clicking “buy now” then entering a PIN to confirm.

The application envisages storing the payment details in the application with PIN protection and transferring those details to a web server over a secure channel. This allows the payment process to be simple, secure and streamlined. The remote server may store some or all of the following information: name, address, mobile number, credit card details, transaction history, additional data gathered through particular types of promotions, and data derived from analysis of raw data.

In addition to providing the tag in the form of a key fob it may be provided as a sticky RFID tag stuck to a handbag or item of clothing or a card for interaction with a handset without contact. It is also envisaged that the application allows tag signals to be generated by users so that users can tailor their tags.

### Cases

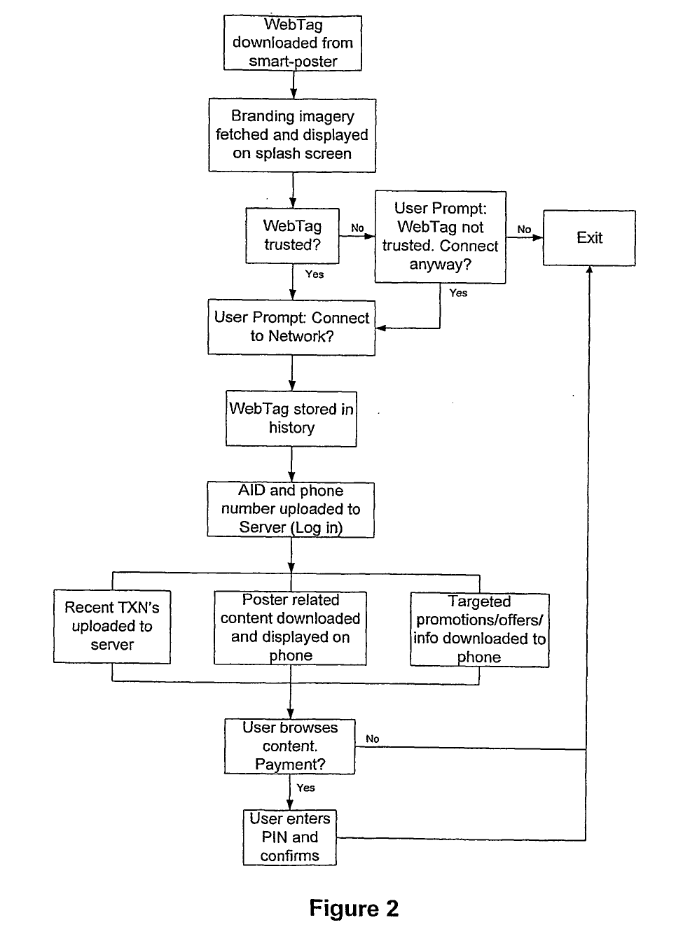

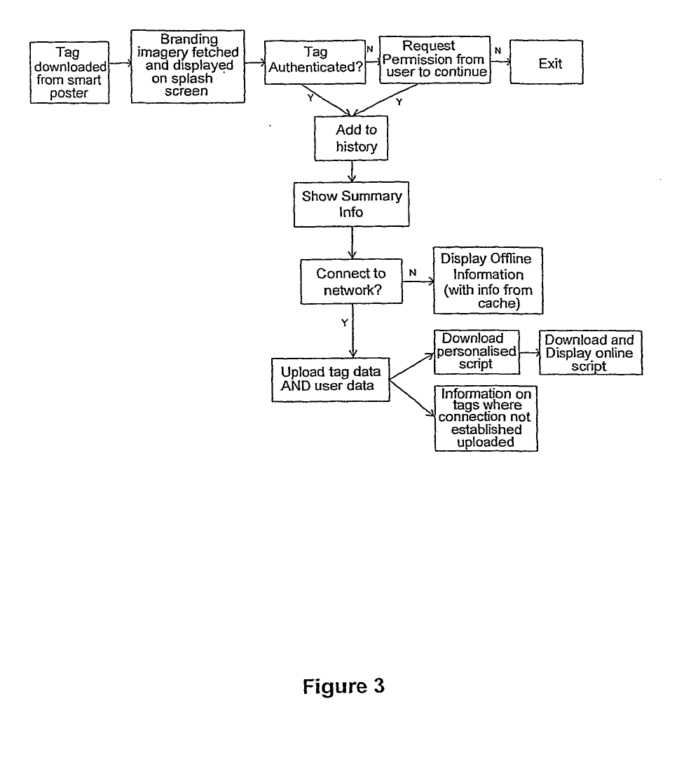

A) The process of FIG. 2 is as follows:
Webtag downloaded from smart-poster;
Branding imagery fetched and displayed on splash screen;
Webtag trusted?;
If no, the system exits;
If yes, the user prompt asks whether the user wishes to connect to the network;
Webtag stored in history;
AID and phone number uploaded to server (login);
Poster related content downloaded and displayed on phone, recent TXN's uploaded to server, and targeted promotions/offers/info downloaded to phone;
User browsers content;
System asks whether payment is necessary;
If no, then the system proceeds to exit; and
If yes, user enters pin and confirms.
   B) The process of FIG. 3 is as follows:
Tag downloaded from smart-poster;
Branding imagery fetched and displayed on splash screen;
Tag authenticated?;
If no, request permission from user to continue;
If no permission is obtained, then the system proceeds to exit;
If the tag is authenticated, then the system proceeds to add to history;
If the request for permission from user to continue is obtained, then the system proceeds to “add to history”;
Add to history;
Show summary info;
Connect to network?;
If no, then display of line information (with info from cache);
If yes, the system uploads tag data and user data;
The system allows download of personalised script followed by the download and display of online script; and
Alternatively, information on tags where connection is not established is uploaded.
   C) FIG. 4, Launching Application with a Personalised Tag

In one embodiment, a user will be able to launch the application by touching a personalised tag to the phone. The tag could come in any number of form factors: RFID tag, contactless smart card, contactless watch and contain user specific data which could be used to authenticate the user to the application. The process is as follows:
The user touches tag to phone;
Application launches and authenticates the tag with the MAC;
Application reads personal data;
Application displays personalised welcome message;
User views list of favourite Webtags; and
User sends one of the favourites to a friend, either by NFC or SMS.

### D) FIG. 5, Targeted Promotional Data

In another embodiment based on the data stored on the server with regards a user's recent transactions, a targeted commercial promotion (in the form of text and an accompanying image) will be uploaded to the to the user's phone next time they connect to the server. This promotion will be stored in the application, and displayed to the user the next time they touch an RFID tag. This means that the user only receives the targeted promotions when they opt in (by touching a tag) and not in an invasive manner (i.e. by SMS).

The process of FIG. 5 is as follows:
User touches new poster tag;
Application authenticates tag;
Application displays the stored promotional image;
Application uploads user history to server;
Server chooses new promotional image based on user's Webtag history;
Server sends promotional image and poster-related material to application;
Application displays poster-related material;
User views poster-related material; and
User closes application.

### E) FIG. 6, Active Tags

An active tag is an RFID tag which has a power source and a data connection. The content of the tag can be updated as and when required by a program running on a back end server. One application of this is to have an active tag attached to a TV screen (whether in some kind of public display, or a home TV screen) which is showing a stream of programs or advertisements. The content of the tag is broadcast to the TV in sync with the programme currently showing and uploaded to the tag such that if a user touches a tag while a particular programme or advertisement is playing, they will be connected to a related web page on their mobile handset.

FIG. 6 is a process as follows:
Server transmits programme number 1 and Webtag number 1;
TV displays programme number 1;
Active tag hosts Webtag number 1;
User views programme number 1 on screen;
User touches phone to tag and downloads Webtag number 1;
User browses web content relating to programme number 1;
Server transmits programme number 2 and Webtag number 2;
TV displays programme number 2;
Active tag hosts Webtag number 2;
User views programme number 2 on screen;
User touches phone to tag and downloads Webtag number 2; and
User browses web content relating to programme number 2.

### F) FIG. 7, Personal Webtags

In a further embodiment the application will contain a “write Webtag” functionality, which will allow users to create their own webtags by specifying what pieces of data they would like to include on the tag—this could be personal data such as their name, mobile phone number, homepage URL etc. For example, say John Smith creates a webtag with his name and mobile number on it, and gives that tag to a new acquaintance (similar to a business card). When the acquaintance touches John's personal tag with their phone, the application will authenticate Webtag as having been written by John Smith, on John Smith's phone.

FIG. 7 shows the following process:
User 1 enters data to be written to Webtag;
Application creates encrypted Webtag from data;
User 1 writes encrypted Webtag onto physical RFID tag;
User 1 distributes RFID tag;
User 2 touches phone to User 1's RFID tag;
Application decrypts Webtag and authenticates it online;
Application displays confirmation of authentication; and
User 2 accesses user 1's data.

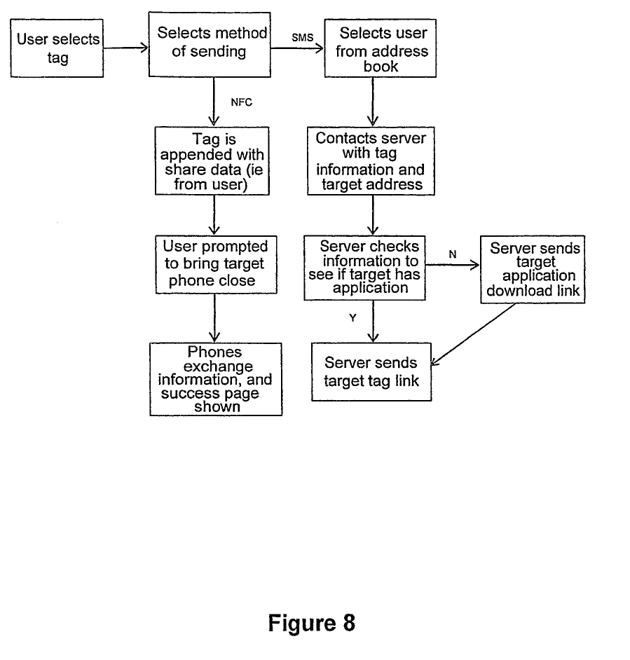

FIG. 8 shows the following process:
User selects tag;
User selects method of sending;
If SMS is selected, User selects User from address book;
Contacts server with tag information and target address;
Server checks information to see if target has application;
If no, the server sends target application download link;
If yes, the server sends target tag link;
If NFC is selected, tag is appended with share data (i.e. from User);
User prompted to bring target phone close; and
Phones exchange information and success page shown.

### G) Payments

In a further embodiment, there are three ways of handling payments within the application:
Prompt user to touch a contactless credit/debit card to the phone. Details are read from the phone and passed over the air to the merchant.
Pay for goods from a credit/debit card stored on the secure chip on the phone
Pay for goods from a PIN protected wallet. In this case the wallet is stored online at the server, so that the application passes the card details to the merchant on behalf of the user. This way, the user never has to enter their details into the phone when making a transaction—nor do they have to store their details on the phone.

In a further embodiment of the invention the system allows: —
Data stored on tag including MAC, brand ID, location, URL;
Synchronisation of tag interactions with server, plus targeted promotions/information in return;
Use of active tags with electronic displays;
Trust of tags inherent within scheme using the MAC on the tag;
Provision of user data to third parties;
Key fob to activate application and authenticate user;
Passing of authenticated tag data by SMS, NFC, Infrared or Bluetooth or other mechanism.

### H) Method of Doing Business

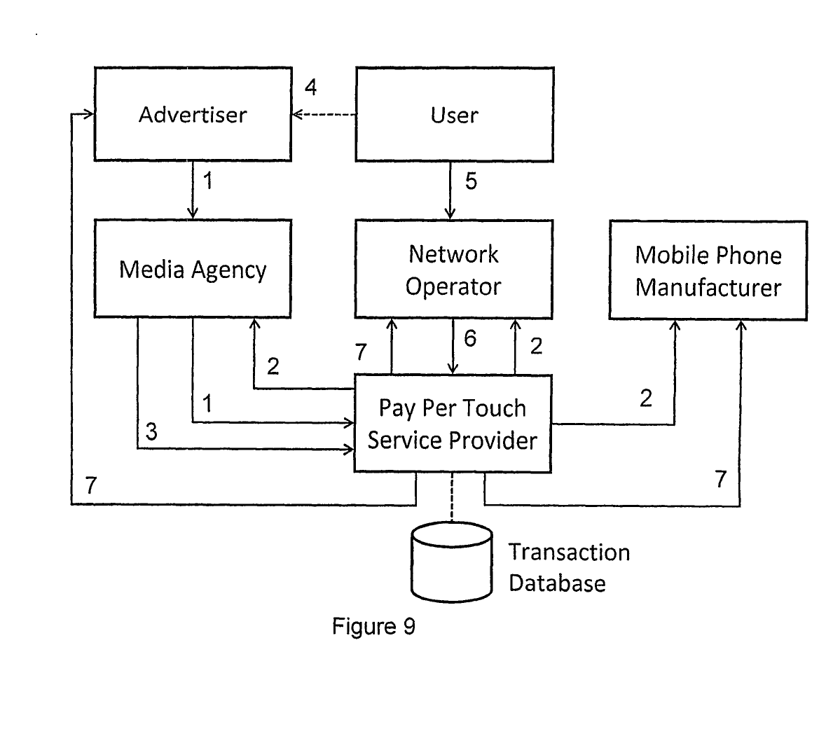

FIG. 9 shows a business model where the model is designed to collect smart-media interaction (such as transactions) information for a service provider facilitating a scheme. One of the methods for a service provider to create revenues from the model is from charging an advertiser for each “touch” that customers make with the NFC smart-media as an advertiser will be able to measure the effectiveness of an advertising campaign and will be (in directly) receiving incremental spend from customers that interact. Each touch will also provide useful information to the advertiser, which is not currently known for any traditional printed media advertising campaign, which has significant value. The diagram provided in FIG. 9 shows how some of the key revenues are shared between entities involved in the scheme, creating value for advertisers, agencies, mobile operators, mobile phone manufactures and NFC smart-media service provider. Ultimately, these revenues flows are the “pay-per-touch” revenues, which are made possible using the scheme specified. The revenues shown in the diagram are:

1. Primary pay-per-touch revenues;
2. Share of pay-per-touch revenues;
3. Pre-campaign fees;
4. Increase in incremental spend;
5. Increase in network traffic spend;
6. Server license fees; and
7. Associated data revenues from analysis of transaction data.

An example of processing means may be a mobile phone application in the form of software written in any one of: Java (J2ME), Symbian, Microsoft Smart-phone, BREW, SIMToolkit, software plug-in for mobile internet browser or other software platform designed for mobile phones running on a phone microprocessor to achieve the functionality outlined above. A preferred implementation may be in Java which is portable across many mobile devices.

Data may be stored in the local file system on the mobile phone either as part of the application or as separate files on the device. As an option, the data could also be stored on removable media such as a SIM or memory card. The data may be stored as part of local storage for a Java application.

1. A communication system, comprising processing means located on a near field communications (NFC) handset incorporating a storage medium for storing signals received, in use, from a tag which is part of a display such as a poster; said storage medium being adapted to store a plurality of signals received, in use, from a plurality of disparate tags; wherein said signals contain at least a Uniform Resource Locator (URL)5 and one or more display specific elements such as a spatial indicator; and wherein said processing means is adapted to upload signals to a remote server when said handset is in an on-line mode of use allowing remote processing means to record and profile a user's interaction with said displays; and is adapted for downloading signals for personalising the user's interaction with said handset when said handset is in an off-line mode of use.

2. A communication system, comprising processing means located on a near field communications (NFC) handset which is adapted to store and transmit signals received from a tag which is part of a display such as a poster; wherein said signals contain at least a Uniform Resource Locator (URL)5 and one or more display specific elements such as a spatial indicator; and processing means located on a remote server with which the handset communicates signals in order to access web-based services relating specifically to said display.

3. A system according to claim 1, wherein said remote server stores signals representative of a user's usage profile.

4. A system according to claim 1, wherein said remote processing means is adapted to send signals to said handset dependent upon a user's usage profile.

5. A system according to claim 1, wherein said remote processing means and said handset processing means are synchronised: whereby said remote processing means is adapted to send signals to said handset processing means when said handset is online without the user having necessarily gone online to run said system.

6. A system according to claim 1, wherein said remote server stores signals representing user data; the user data being collected by the server addressing single sporadic questions.

7. A system according to claim 1, wherein the communication system comprises a tag incorporating a memory chip and an aerial wound around the perimeter of the chip.

8. A system according to claim 7, wherein the tag is covered with adhesive.

9. A system according to claim 1, wherein the communication system comprises a tag, which is connected to a power source and communicates signals to a remote database.

10. A system according to claim 9, wherein said tag is synchronised with video or audio on any appropriate device.

11. A system according to claim 9, wherein said tag is incorporated as part of an electronic display.

12. A system according to claim 1, wherein the communication system comprises a tag with processing means for emitting signals with a message authentication code.

13. A system according to claim 1, wherein the communication system comprises a tag in the form of a fob such as a key fob.

14. A system according to claim 1, wherein said signals comprise a uniform resource identifier, a brand ID and a message authentication code.

15. A system according to claim 14, wherein said signals comprise a tag location.

16. A system according to claim 15, wherein said signals comprise a tag ID and a description suitable, for being displayed on a handset.

17. A system according to claim 1, further comprising storage for storing signals representative of a user's interaction with a tag; said storage being in the form of a history and/or a favourites list; and a transmitter operating in conjunction with said storage allow transmission of signals from said storage to another user; whereby peer to peer communication is established.

18-25. (canceled)

26. A method of doing business comprising the steps of:
Providing a number of Near Field Communication (NFC) tags;
Recording individual interactions of a handset with said tags; and
Charging for a service dependent upon said recorded interactions.

27. (canceled)

28. A method of communication, comprising the steps of:
providing processing means located on a near field communications (NFC) handset incorporating a storage medium for storing signals received, in use, from a tag which is part of a display such as a poster;
storing a plurality of signals received, in use, from a plurality of disparate tags; wherein said signals contain at least a Uniform Resource Locator (URL), and one or more display specific elements such as a spatial indicator; and
uploading signals to a remote server when said handset is in an on-line mode of use allowing remote processing means to record and profile a user's interaction with said displays; and downloading signals for personalising the user's interaction with said handset when said handset is in an off-line mode of use.

29. A method of communication comprising the steps of:
providing processing means located on a near field communications (NFC) handset which is adapted to store and transmit signals received from a tag which is part of a display such as a poster; wherein said signals contain at least a Uniform Resource Locator (URL), and one or more display specific elements such as a spatial indicator; and
establishing communication between a remote server and a handset dependent upon said signals in order to access web-based services relating specifically to said display.

30-49. (canceled)
